(19) United States
(12) Patent Application Publication
(10) Pub. No.: US 2010/0049686 A1
(43) Pub. Date: Feb. 25, 2010

(54) METHODS AND APPARATUS FOR VISUAL RECOMMENDATION BASED ON USER BEHAVIOR

(75) Inventors: David H. Gotz, Purdys, NY (US); Zhen Wen, Chappaqua, NY (US); Michelle X. Zhou, Briarcliff Manor, NY (US)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/194,657

(22) Filed: Aug. 20, 2008

(51) Int. Cl. G06N 5/02

(52) U.S. Cl. 706/47; 706/46; 706/55

(57) ABSTRACT

Methods and apparatus are disclosed for dynamically recommending one or more visualizations for a given task based on user behavior, such as a user's interaction pattern with a current visualization. An alternate visualization type is provided to a user by observing actions of the user with a current visualization type; determining if one or more predefined action patterns is detected in the observed actions, wherein at least one of the predefined action patterns has a predefined associated alternate visualization type; and providing the alternate visualization type to the user when the associated predefined action pattern is detected. The one or more predefined action patterns may be defined by one or more rules or an example-based method.

### FIELD OF THE INVENTION

The present invention relates to data visualization systems and, more particularly, relates to methods and apparatus for recommending alternate visualization types based on user behavior.

### BACKGROUND OF THE INVENTION

Interactive visual dialog systems aid users in investigating large and complex data sets. There is a large class of users for whom existing tools are of limited value. Many business users, for example, typically have extensive domain knowledge but are not visualization or computer experts. As part of their daily responsibilities, however, they perform situational analysis tasks over large amounts of data for which appropriate visualization can be of great benefit. It is difficult for this class of users to create visualization that is tailored to the user's context.

When the employed visualization is not well-suited to the user's information needs, more time may be spent than necessary interacting with the visualization. As a result, it may significantly slow down the user's task performance. Furthermore, previous studies have shown that users tend to stay with the unsuitable visualization instead of switching visualizations. See, for example, A. Kobsa, “An Empirical Comparison of Three Commercial Information Visualization Systems,” Proc. of IEEE InfoVis, 123-130, 2001.

A number of techniques have been proposed or suggested for automated graphics generation. For instance, example-based approaches have been proposed to automatically create visualization from a wide variety of graphic examples. See, for example, M. X. Zhou and M. Chen, “Automated Generation of Graphic Sketches by Example,” Proc. of IJCAI, 65-74 (2003). Typically, such proposed techniques address explicit input factors, including data properties and user-chosen task type. In practical application scenarios, however, automatically generated visualization may not always be suitable for given input data, since certain data properties can be difficult to obtain (e.g., data semantics). Moreover, users' information needs are constantly evolving and users may not be able map their information needs to visualization tasks because they are not visualization experts. If the automatically generated visualization happens to be unsuitable for user tasks, users may waste a lot of time in repeated interaction.

A need therefore exists for improved methods and apparatus for dynamically recommending one or more visualizations for a given task based on user behavior. A further need exists for improved methods and apparatus for dynamically recommending one or more alternate visualizations based on observed user interaction patterns with a current visualization.

### SUMMARY OF THE INVENTION

Generally, methods and apparatus are disclosed for dynamically recommending one or more visualizations for a given task based on user behavior, such as a user's interaction pattern with a current visualization. According to one aspect of the invention, an alternate visualization type is provided to a user by observing actions of the user with a current visualization type; determining if one or more predefined action patterns is detected in the observed actions, wherein at least one of the predefined action patterns has a predefined associated alternate visualization type; and providing the alternate visualization type to the user when the associated predefined action pattern is detected.

The one or more predefined action patterns may be defined by one or more rules that comprise a semantic type and a set of parameters describing a focus of the pattern. Alternatively, the predefined action patterns may be defined by an example-based method. Generally, each rule specifies one or more conditions under which a user behavior pattern is associated with a visual task. The predefined action patterns can be detected, for example, by comparing a representation of recent interaction behavior of the user with a set of pattern definitions. A definition of the predefined action patterns can comprise a type, one or more sequence rules, and one or more generalization requirements. The type can represent a semantic intent of the pattern. The sequence rules can be paired with a generalization requirement. Each sequence rule can be a regular expression capturing a sequence of user actions that can embody a corresponding pattern type.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a user behavior-driven visual recommendation system incorporating features of the present invention;

FIGS. 2A and 2B illustrate an example for visual recommendation based on a scan pattern;

FIGS. 3A and 3B illustrate an example for visual recommendation based on a flip pattern;

FIGS. 4A and 4B illustrate an example for visual recommendation based on a swap pattern;

FIG. 5 illustrates an exemplary pattern rule-base incorporating features of the present invention; and

FIG. 6 is a flow chart of an exemplary visual recommendation process incorporating features of the present invention.

### DETAILED DESCRIPTION OF PREFERRED EMBODIMENTS

The present invention provides improved methods and apparatus for dynamically recommending one or more visualizations for a given task based on user behavior. According to one aspect of the invention, alternate visualizations are recommended based on observed user interaction patterns with visualization. By associating a detected user pattern with an appropriate visual task, the disclosed invention can recommend a more suitable visualization than the automatically generated visualization. According to a further aspect of the invention, the semantics of user interaction with visualization are extracted and used to recommend one or more visualizations based on the extracted semantics.

The disclosed visualization recommendations can be tailored to dynamic user behavior. A user's behavior during visual analysis often signals implicit analytic needs. Assume that a particular user is comparing hotel information (e.g., prices) using a map-based visualization. The user might examine several different hotels by clicking on each one in sequence.

To better help the user in the above situation, a rule-based approach can be employed to make pattern-based visualization recommendations. Each rule maps a user action pattern to an implied visual task. For example, the pattern demonstrated by the user in this example can be mapped to a visual comparison task. Based on the inferred visual task, the disclosed visualization recommendation engine suggests suitable visualizations. This type of action is referred to herein as a scan pattern. Once the pattern is detected, the disclosed engine can recommend, for example, the use of a bar chart to encode the desired information for comparison. As a result, the recommended visualization not only better meets a user's needs, but it also reduces the number of required user actions.

FIG. 1 is a schematic block diagram of a user behavior-driven visual recommendation system 100 incorporating features of the present invention. As shown in FIG. 1, the visual recommendation system 100 comprises an action tracker 110, a visualization block 120 and a visualization recommender 130. The action tracker 110 and visualization recommender 130 are discussed further below in sections entitled Action Tracker and Visualization Recommender, respectively. Given a sequence of user interactions 114 with visualization 120, the action tracker 110 extracts the semantics of the interactions 114, such as the interaction type (e.g., Filter) and interaction parameters (e.g., dimensions of interests), as discussed further below. Thereafter, the action tracker 110 detects whether any patterns 118 occur in the sequence of interactions 114. Based on the detected pattern 118, the visualization recommender 130 selects one or more appropriate visualizations 150 that can be presented to the user as alternatives to the visualization type currently being used.

Example Scenarios

A set of examples are discussed to show how the present invention can recommend an appropriate visualization 150 based on different user behavior patterns 118.

1. Scan Pattern

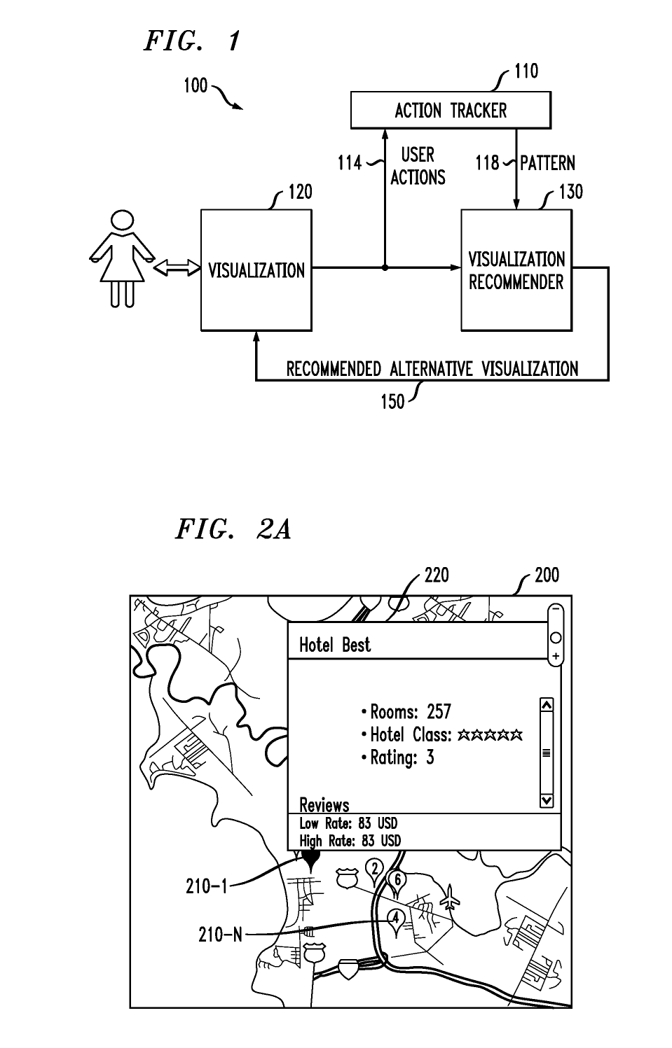

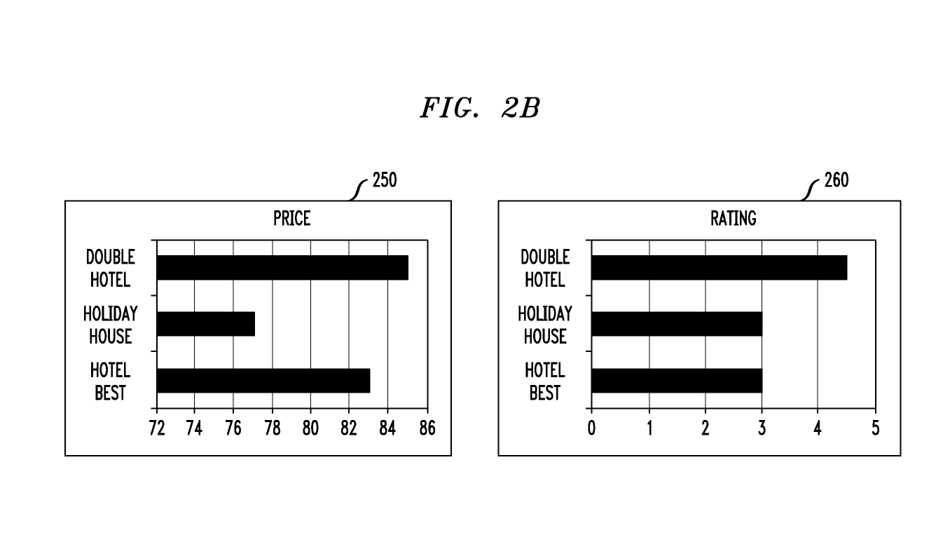

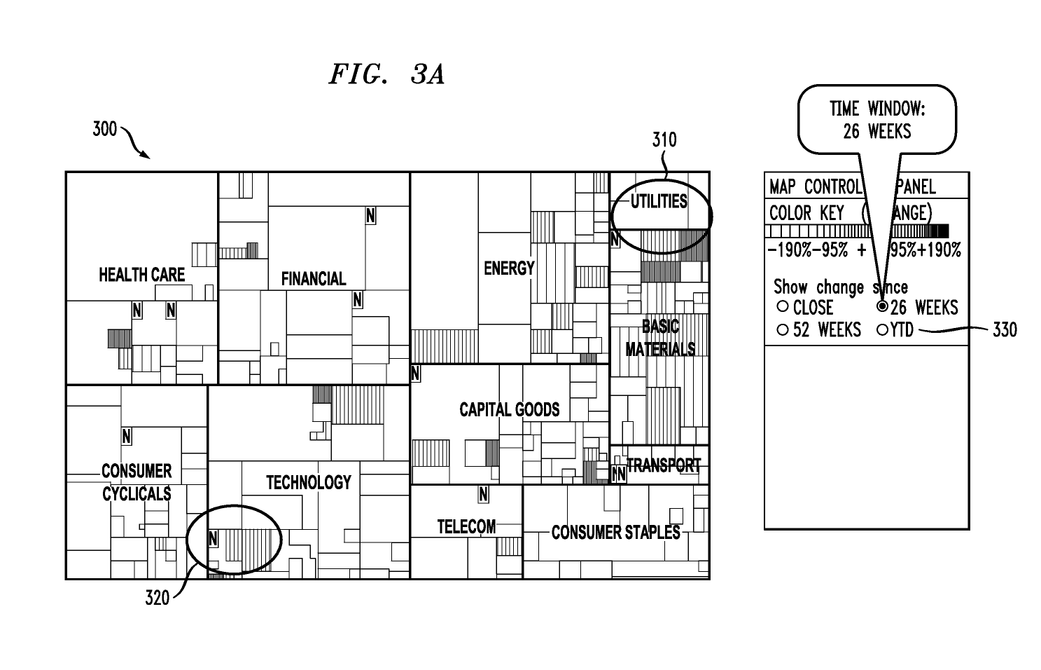

FIGS. 2A and 2B illustrate an example for visual recommendation based on a scan pattern. Assume that a user is interacting with a map to find a suitable hotel from a number of candidate hotels. As shown in FIG. 2A, a user clicks on a number of hotel icons 210-1 through 210-N on a graphical interface 200 to compare information about each hotel. To compare the attributes of each of the hotels, the user clicks on a given hotel icon, for example 210-1, and a corresponding dialog box 220 is presented with information about the hotel associated with the selected icon 210-1. This sequence of actions is often referred to as a scan pattern. Typically, the user repeats his or her actions by clicking on the icons 210-1 through 210-N for all hotels on the interface 200. Upon detecting the predefined user behavior associated with the scan pattern, the present invention recommends, for example, one or more bar chart visualizations 250, 260, as shown in FIG. 2B, to allow the user to directly compare hotel price and rating information, respectively, for each hotel.

2. Flip Pattern

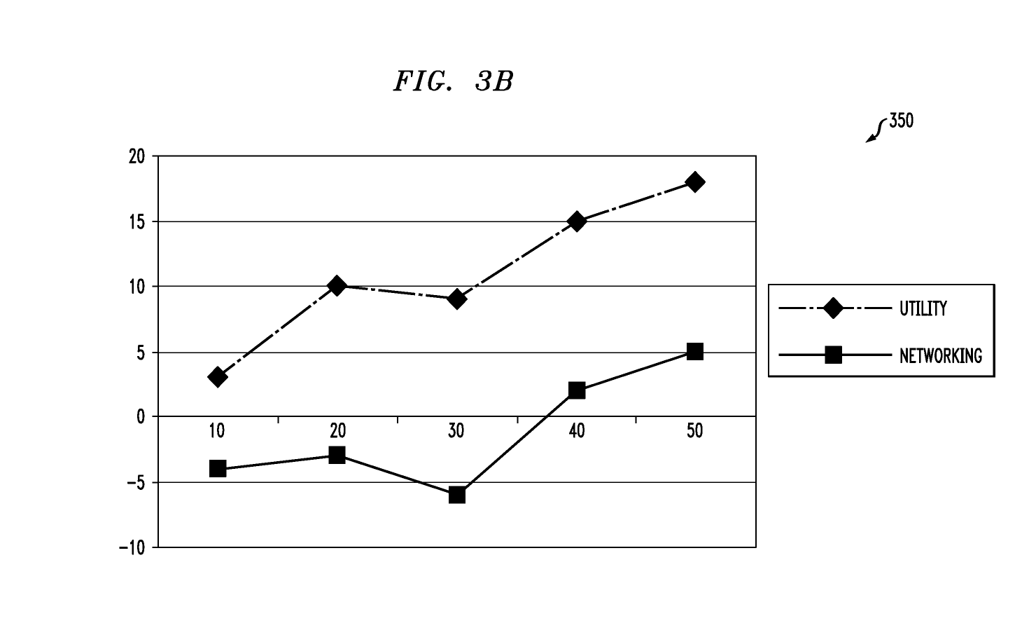

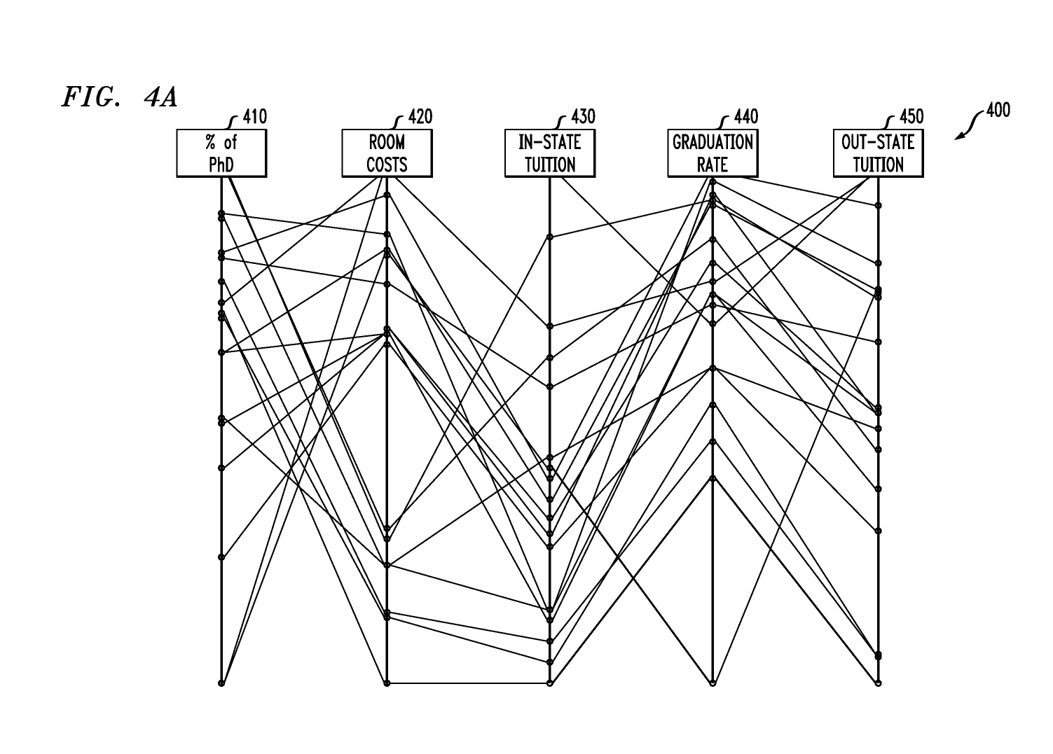

FIGS. 3A and 3B illustrate an example for visual recommendation based on a flip pattern. Assume that a user keeps changing the time setting of a treemap visualization 300 between two values in a time selection window 330, such as 26 weeks and 52 weeks, referred to as a flip pattern. As shown in FIG. 3A, the user employs the treemap visualization 300 to analyze stock market trends for a utility market segment 310 and a networking market segment 320. To understand the stock price trend over time, the user needs to view the stock information at different times. The treemap 300 only shows a snapshot of the stock market at one time setting. Thus, the user must change the time setting back and forth. Upon detecting the predefined user behavior associated with the flip pattern, the present invention recommends, for example, a line chart visualization 350 (FIG. 3B) to allow the user to directly view and compare stock information over time.

3. Swap Pattern

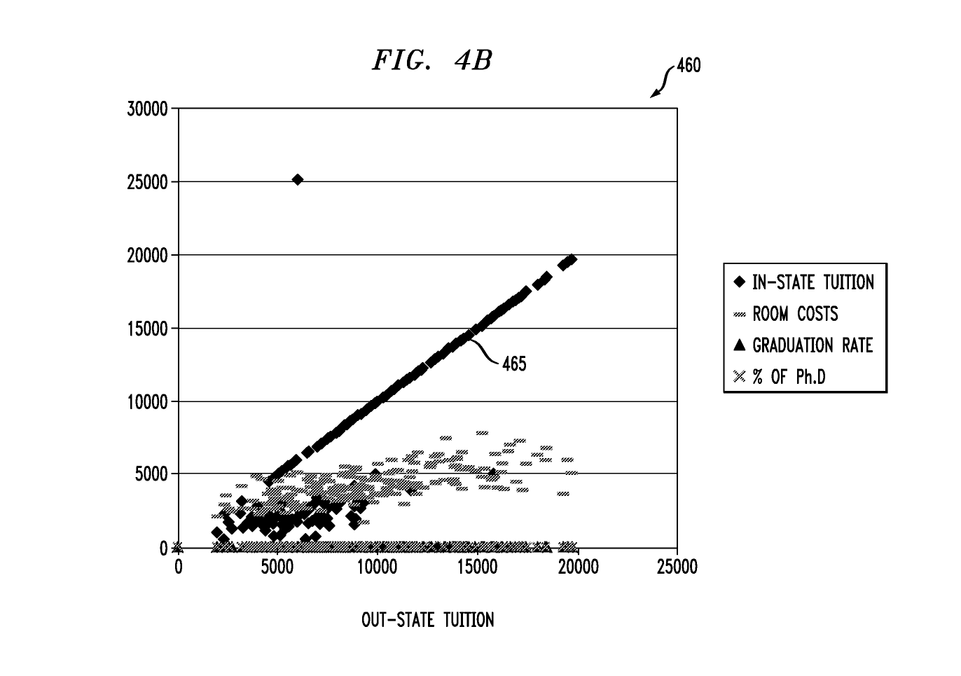

FIGS. 4A and 4B illustrate an example for visual recommendation based on a swap pattern. Assume that a user keeps swapping axes of a parallel coordinates visualization 400 to study the correlation between graduation rate and other attributes. As shown in FIG. 4A, each axis is associated with a different college attribute, such as PhD percentage 410, room costs 420, in-state cost 430, graduation rate 440 and out-of-state cost 450. To find the correlation between the “graduation rate” 440 and other attributes, for example, the user reorders the axes repeatedly to bring the “graduation rate” axis 440 side by side with each of the other axes.

Upon detecting the predefined user behavior associated with the swap pattern, the present invention recommends, for example, a scatter plot visualization 460 (FIG. 4B) to directly visualize multiple correlations between “Out-of-state tuition” and other attributes at the same time. In this manner, one aspect of the present invention reduces the need to repeatedly “swap” axes.

Action Tracker

As discussed above in conjunction with FIG. 1, the action tracker 110 detects predefined patterns 118 over the user's recently performed actions 114 in search of meaningful activity. In one exemplary embodiment, the present invention defines a pattern 118, such as a scan, flip or swap pattern, in terms of a plurality of predefined user actions 114 associated with the pattern. Upon detecting the predefined user behavior associated with a given pattern, the present invention recommends one or more appropriate visualizations associated with the recognized pattern 118. For example, a scan pattern occurs when a user successively inspects a series of visual objects that represent similar sets of data. Likewise, a flip pattern occurs when a user switches between different data constraint values along a particular dimension.

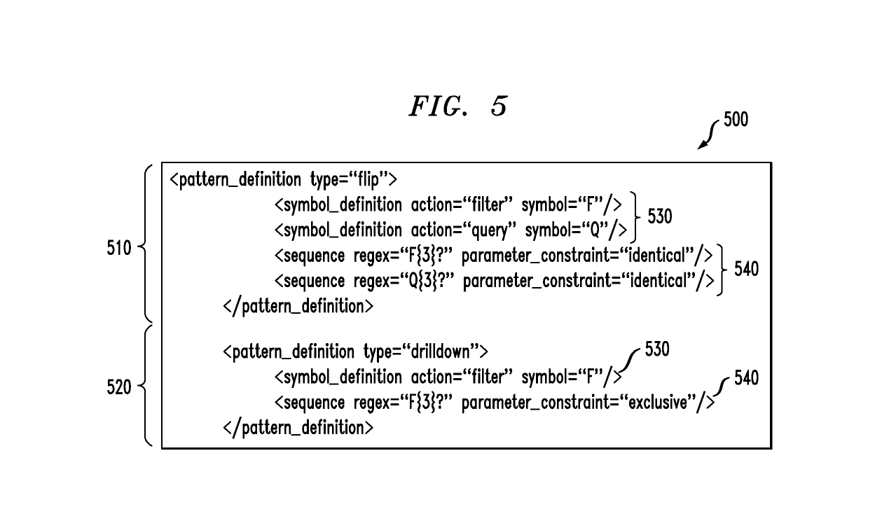

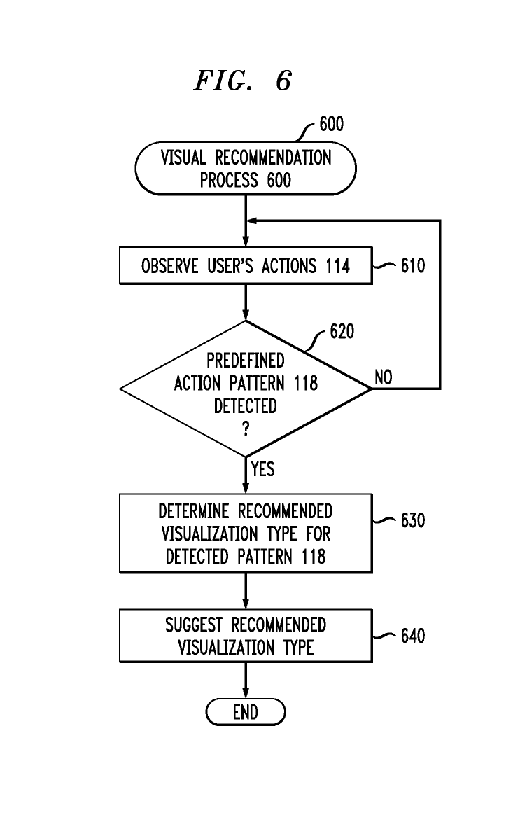

In one exemplary implementation, a rule-based approach is used for pattern detection. FIG. 5 illustrates an exemplary pattern rule-base 500 incorporating features of the present invention. As shown in FIG. 5, each exemplary rule, such as rules 510, 520, optionally includes two parts 530, 540. A first part 530 comprises a regular expression that encodes the required sequence of actions 114. A second part 540 comprises a set of generalization guidelines that specify how the parameters for the individual actions in the pattern should be generalized.

Generally, if a sequence of actions 114 matches the regular expression 530 of a given rule and has parameters that can be generalized according to the guidelines 540 of the rule, then the sequence of actions 114 is considered to be a pattern. For example, the scan pattern is defined by a regular expression I{4,} (which matches sequences of four or more Inspects) and generalization guidelines that require the parameters of the Inspect actions to reference the same type of data objects.

Once a pattern 118 is detected, both the pattern type (e.g., Scan) and its parameters (e.g., “project funding partners”) are reported back to the action tracker 110. The detected pattern 118 is then used by the visualization recommender 130, discussed further in the following section, to dynamically provide suitable visualizations that better help users in their tasks.

Visualization Recommender

As previously indicated, the visualization recommender 130 selects one or more appropriate visualizations 150 based on a detected pattern 118. The appropriate visualizations 150 can be presented to the user as alternatives to the visualization type currently being used.

To better adapt visualization to user behavior, an implementation of the present invention employs a rule-based approach to make pattern-based visualization recommendations. Each rule maps a user action pattern 118 to an implied visual task. In one implementation, the rule-base 500 of FIG. 5 can be extended to map a given predefined user action pattern 118 to an implied visual task, with an associated recommended visualization type.

The scan pattern 118 demonstrated by users in the example of FIG. 2 (inspecting several similar visual objects), for example, is mapped to a visual comparison task. Based on the inferred visual task, the visual recommendation system 100 suggests one or more visualization types that are suitable for the task. In the exemplary embodiment, the action tracker 110 is responsible for dynamically identifying user action patterns 118. Continuing the above example, the action tracker 110 detects a scan pattern 118 based on the user's repetitive actions 114. Once the scan pattern 118 is detected, the visual recommendation system 100 recommends the use of a bar chart 250, 260 to encode the desired information for comparison. In this manner, the recommended visualization better meets a user's needs while also reducing the number of required user actions.

Visual Recommendation Process

FIG. 6 is a flow chart of an exemplary visual recommendation process 600 incorporating features of the present invention. As shown in FIG. 6, the visual recommendation process 600 initially observes a user's actions 114 during step 610. A test is performed during step 620 to determine if a predefined action pattern 118 is detected. Once it is determined during step 620 that a predefined action pattern 118 is detected, then a recommended visualization type for the detected pattern 118 is determined during step 630. The recommended visualization type is then suggested to the user during step 640 before program control terminates.

Example-Based Method

An alternative to the rule-based approach to pattern detection discussed above in conjunction with FIG. 5 is to use an example-based method. In this approach, instead of a fixed set of rules 510, 520, each type of pattern 118 is defined by a set of features extracted from one or more example action sequences. Each example action sequence can be a trace of user activity that serves as an exemplar of a particular type of pattern 118. For example, to define a scan pattern using the example-based approach, the system 100 could use a set of features extracted from one or more user action sequences in which the user performed a scan pattern. The set of features extracted from these exemplars would be used in place of rules 510, 520 to define the pattern. Under the example-based approach, a set of features from the user's active trail are compared to the feature sets for each example-based definition. For each definition, a distance is computed between the two sets of features and the definition with the smallest distance is considered the best match.

Given a user request, from a database of visualization examples, the disclosed example-based learning uses a similarity metric to retrieve the examples that are most similar to the request. The top-N matched examples are then directly reused for or adapted to the new situation (e.g., new data). In one embodiment, a polynomial-time, dynamic programming approach can be employed to approximate graph-based example matching.

Conclusion

While FIG. 6 shows an exemplary sequence of steps, it is also an embodiment of the present invention that the sequence may be varied. Various permutations of the algorithm are contemplated as alternate embodiments of the invention.

While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

The visual recommendation system 100 comprises memory and a processor that can implement the processes of the present invention. Generally, the memory configures the processor to implement the visual recommendation processes described herein. The memory could be distributed or local and the processor could be distributed or singular. The memory could be implemented as an electrical, magnetic or optical memory, or any combination of these or other types of storage devices. It should be noted that each distributed processor that makes up the processor generally contains its own addressable memory space. It should also be noted that some or all of visual recommendation system 100 can be incorporated into a personal computer, laptop computer, handheld computing device, application-specific circuit or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A method for providing an alternate visualization type to a user, comprising:
observing actions of said user with a current visualization type;
determining if one or more predefined action patterns is detected in said observed actions, wherein at least one of said predefined action patterns has a predefined associated alternate visualization type; and
providing said alternate visualization type to said user when said associated predefined action pattern is detected.

2. The method of claim 1, wherein said providing step further comprises the step of recommending said alternate visualization type to said user.

3. The method of claim 1, wherein said one or more predefined action patterns comprises a semantic type and a set of parameters describing a focus of the pattern.

4. The method of claim 1, wherein said determining step further comprises the step of comparing a representation of recent interaction behavior of said user with a set of pattern definitions.

5. The method of claim 1, wherein said predefined action pattern is defined by one or more rules.

6. The method of claim 5, wherein a definition of said one or more predefined action patterns comprises a type, one or more sequence rules, and one or more generalization requirements.

7. The method of claim 6, wherein said type represents a semantic intent of said pattern.

8. The method of claim 7, wherein each of said sequence rules is paired with a generalization requirement.

9. The method of claim 8, wherein each sequence rule is a regular expression capturing a sequence of user actions that can embody a corresponding pattern type.

10. The method of claim 8 wherein each generalization requirement specifies one or more requirements to be met by parameters of actions in a matching sequence to satisfy said definition.

11. The method of claim 5, wherein each rule specifies one or more conditions under which a user behavior pattern is associated with a visual task.

12. The method of claim 4, wherein said representation matches a definition if one or more sequence rules is satisfied while also satisfying any paired generalization requirements.

13. The method of claim 4, wherein the step of comparing said representation against a set of pattern definitions may use an example-based method.

14. The method of claim 1, wherein said predefined action pattern is defined by one or more example action sequences.

15. The method of claim 14, wherein said predefined action pattern comprises a type and one or more features computed from past examples of the pattern.

16. The method of claim 14, wherein a representation of recent interaction behavior of said user is compared against each of said predefined action patterns by computing a distance between said representation and each of the predefined action patterns based on features.

17. The method of claim 16, wherein said representation matches a predefined action pattern if the distance between the representation and the predefined action pattern is the smallest.

18. The method of claim 14, further comprising the step of associating user behavior patterns with visual tasks using a method based on past examples of behavior pattern and corresponding visual task types.

19. The method of claim 18, wherein the example-based method compares the current user behavior pattern with past pattern examples.

20. The method of claim 19, wherein the current user behavior pattern is associated with the visual task that corresponds to the most similar past pattern example.

21. A system for providing an alternate visualization type to a user, said system comprising:
a memory; and
at least one processor, coupled to the memory, operative to:
observe actions of said user with a current visualization type;
determine if one or more predefined action patterns is detected in said observed actions, wherein at least one of said predefined action patterns has a predefined associated alternate visualization type; and
provide said alternate visualization type to said user when said associated predefined action pattern is detected.

22. An article of manufacture for providing an alternate visualization type to a user, comprising a machine readable storage medium containing one or more programs which when executed implement the steps of:
observing actions of said user with a current visualization type;
determining if one or more predefined action patterns is detected in said observed actions, wherein at least one of said predefined action patterns has a predefined associated alternate visualization type; and
providing said alternate visualization type to said user when said associated predefined action pattern is detected.
